(19) United States
(12) Patent Application Publication
(10) Pub. No.: US 2021/0283018 A1
(43) Pub. Date: Sep. 16, 2021

(54) PILL ORGANIZER

(71) Applicant: ZHUHAI EKTOUCH TECHNOLOGY CO., LTD., ZHUHAI (CN)

(72) Inventors: JINPENG GUO, ZHUHAI (CN); WEI DU, ZHUHAI (CN)

(21) Appl. No.: 16/878,647

(22) Filed: May 20, 2020

(30) Foreign Application Priority Data
Mar. 10, 2020 (CN) 202020286174.X

(51) Int. Cl. A61J 7/00

(52) U.S. Cl. CPC A61J 7/0084

(57) ABSTRACT

The present disclosure provides a pill organizer. The pill organizer comprises a box body. The box body comprises at least one pill storage cavity and at least one cover. The pill storage cavity defining an upper end opening. The cover is matched with the upper end opening and is disposed on the upper end opening of the pill storage cavity. One end of the cover is rotatably connected with the box body. Another end of the cover is detachably buckled with the box body. An elastic piece is disposed om an inner surface of the one end of the cover rotatably connected with the box body. One end of the elastic piece is fixed on the box body. Another end of the elastic piece of the covers is buckled with one side of the pill storage cavity of the box body.

### CROSS-REFERENCE TO RELATED APPLICATION

The present application claims foreign priority to Chinese Patent Application No. CN202020286174.X, titled “PILL ORGANIZER WITH BUCKLED ELASTIC PIECE,” tiled on March 10, 2020 in the State Intellectual Property Office of China, and the entire contents of which is hereby incorporated by reference.

### TECHNICAL FIELD

The present disclosure relates to a field of pill boxes, and in particular to a pill organizer with a buckled elastic piece.

### BACKGROUND

A pill box on the market generally comprises an upper cover and a main body. The upper cover of the pill box is integrally connected with the main body of the pill box. And when the upper cover is in a closed position, the upper cover is deformed and bent. When unlocking the upper cover, the upper cover is automatically opened by force generated by deformation of the upper cover. However, due to high strength of the upper cover, deformation recovery of the upper cover is small, resulting in that the upper cover cannot be fully opened automatically, and require users to open the upper cover manually, which is inconvenient for the users to take out or replenish pills. In addition, since the pill box is closed most of the time and the upper cover is deformed and bent at the closed position for a long time, the upper cover is easily damaged, which greatly shorten service life of the pill box, and also affect sealing property of the pill box.

### SUMMARY

In order to solve above problems in the prior art, the present disclosure provides a pill organizer with a buckled elastic piece. A cover of the pill organizer with a buckled elastic piece is able to be fully opened automatically, which is convenient to take out and replenish pills, and simple and fast in operation. Moreover, when the cover is in a closed state, a sealing effect of the pill organizer with the buckled elastic piece is stable and reliable, and a service life is long. Further, the pill organizer with the buckled elastic piece has ingenious and compact structure, which is quick and convenient to assemble, and is easy to produce.

To achieve the above objection, the present disclosure provides a pill organizer. The pill organizer comprises a box body. The box body comprises at least one pill storage cavity and at least one cover. The pill storage cavity defining an upper end opening. The cover is matched with the upper end opening and is disposed on the upper end opening of the pill storage cavity. One end of the cover is rotatably connected with the box body. Another end of the cover is detachably buckled with the box body. An elastic piece is disposed om an inner surface of the one end of the cover rotatably connected with the box body. One end of the elastic piece is fixed on the box body. Another end of the elastic piece of the covers is buckled with one side of the pill storage cavity of the box body.

Furthermore, an upper edge of one side wall of the pill storage cavity has a recess. Another end of the elastic piece of the cover is buckled with the recess.

Furthermore, a clamping seat is disposed on a rear end of an inner surface of the cover. An engaging hole is disposed on the clamping seat. The elastic piece is an S-shaped elastic piece or an L-shaped elastic piece. The one end of the elastic piece comprises an inverse clamping head. And the another end of the elastic piece comprises a curved buckling portion. During assembly, the curved buckling portion passes through the engaging hole and hooks on an edge of the engaging hole, and the curved buckling portion is buckled with the recess.

Furthermore, the clamping seat and is integrated together with the cover. The inverse clamping head and the curved buckling portion are integrated together with the elastic piece.

Furthermore, the elastic piece is an elastic plastic piece or an elastic metal piece.

Furthermore, an rear end of the cover is rotatably connected with an rear end of the pill storage cavity of the box body. A front end of the cover is detachably buckled with a front end of the pill storage cavity of the box body. The one end of the elastic piece is fixed on an inner surface of the rear end of the cover. The another end of the elastic piece is buckled with the rear end of the pill storage cavity of he box body.

Furthermore, a locking buckle matched with the pill storage cavity is disposed on a front end of the box body. A buckle hole is disposed on the front end of the cover. The buckle hole of the cover is buckled with the locking buckle when the cover is closed.

Furthermore, the box body comprises at least one row of pill storage cavities arranged side by side along a longitudinal direction of the box body.

Furthermore, the box body is assembled from more than one pill box bodies. Two adjacent pill body bodies are connected by magnetic attraction. Each of the pill box bodies comprises the at least one pill storage cavity defining the upper end opening and at least one cover.

The cover of the pill organizer of the present disclosure is able to be fully opened automatically, which is convenient to take out and replenish pills, and is simple and fast in operation. Moreover, when the cover is in a closed state, the sealing effect of the pill organizer is stable and reliable, and a service life is long. Further, the pill organizer has an ingenious and compact structure, which is quick and convenient to assemble, is easy to produce, and is conducive to mass production and popularization.

### BRIEF DESCRIPTION OF DRAWINGS

FIG. 1 is a schematic diagram showing a structure of a pill organizer according to a first embodiment of the present disclosure.

FIG. 2 is an enlarged schematic structural view of portion A shown in FIG. 1.

FIG. 3 is a schematic diagram showing a structure of an elastic piece of the pill organizer according to the first embodiment of the present disclosure.

FIG. 4 is an enlarged schematic view of a partial structure of a pill organizer according to a second embodiment of the present disclosure.

FIG. 5 is a schematic diagram showing a structure of an elastic piece of a pill organizer according to the second embodiment of the present disclosure.

### DETAILED DESCRIPTION

In order to make the purpose, technical solutions and advantages of the present disclosure more clear, the present disclosure will be described in further detail below with reference to the accompanying drawings and embodiments. It should be understood that the specific embodiments described below are only used to explain the present disclosure, and are not intended to limit the present disclosure.

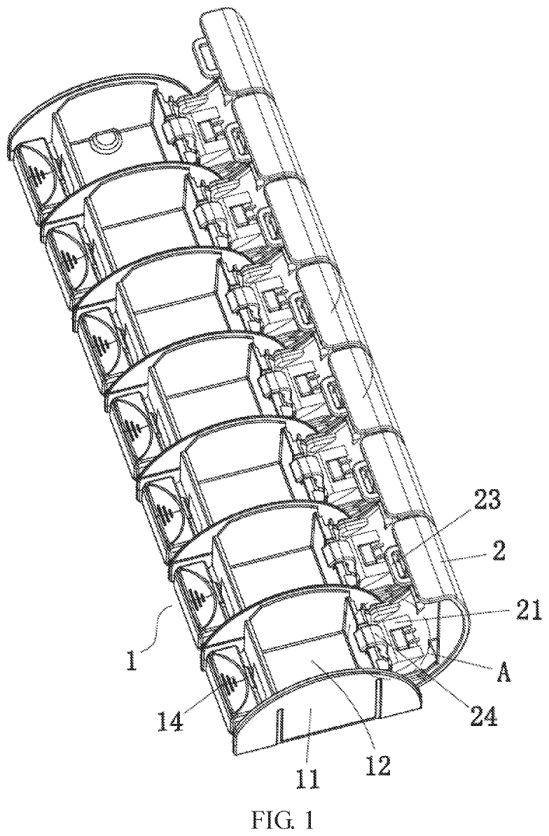

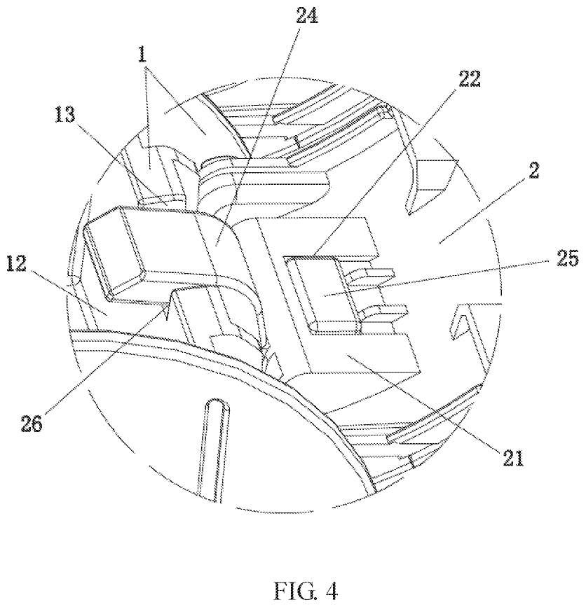

As shown in FIGS. 1-5, a first embodiment and a second embodiment of the present disclosure provides a pill organizer with a buckled elastic piece. The pill organizer comprises a box body 1. The box body 1 comprises at least one pill storage cavity 12 and at least one cover 2. The pill storage cavity 12 defines an upper end opening. The cover 2 is matched with the upper end opening and is disposed on the upper end opening of the pill storage cavity 12. One end of the cover 2 is rotatably connected with the box body 1. Another end of the cover 2 is detachably buckled with the box body 1. An elastic piece 24 is disposed om an inner surface of the one end of the cover 2 rotatably connected with the box body 1. One end of the elastic piece 24 is fixed on the box body 1. Another end of the elastic piece 24 of the cover 2 is buckled with one side of the pill storage cavity 12 of the box body 1.

Specifically, the box body 1 comprises at least one row of pill storage cavities 12 arranged side by side along a longitudinal direction of the box body 1. Covers 2 are one to one arranged on pill storage cavities 12. An rear end of each cover 2 is rotatably connected with an rear end of each pill storage cavity 12 of the box body 1. A front end of each cover 2 is detachably buckled with a front end of each pill storage cavity 12 of the box body 1. The one end of each elastic piece 24 is fixed on an inner surface of the rear end of each cover 2. The another end of each elastic piece 24 is buckled with the rear end of each pill storage cavity 12 of he box body 1.

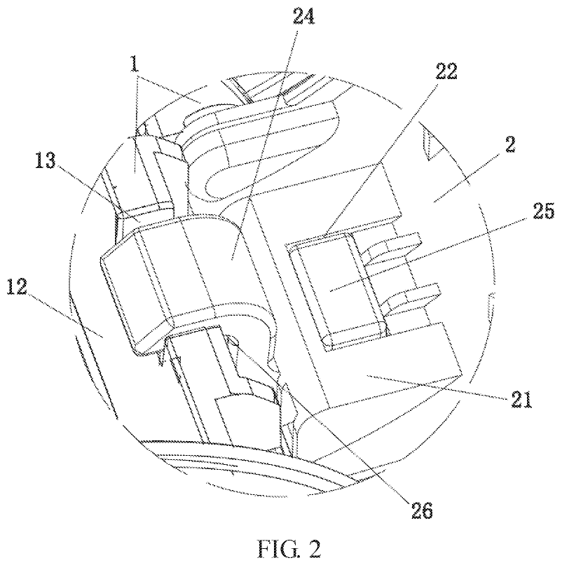

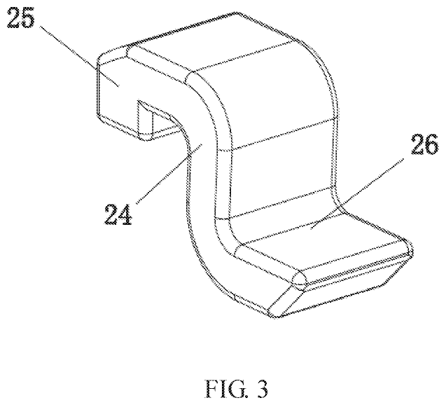

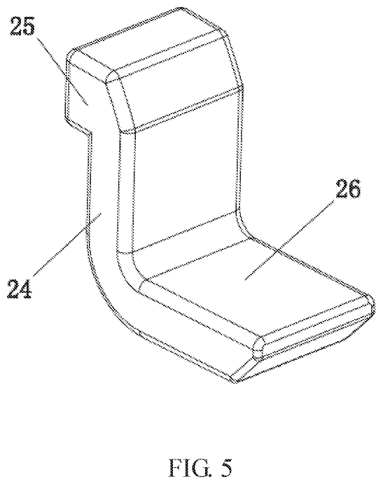

As shown in FIGS. 1-2, a clamping seat 21 is disposed on a rear end of an inner surface of each cover 2. An engaging hole 22 is disposed on each clamping seat 21. Each clamping seat 21 is integrated together with each cover 2 (e.g., each clamping seat 21 and each cover 2 are integrally injection molded). As shown in FIGS. 3 and 5, each elastic piece 24 is an S-shaped elastic piece or an L-shaped elastic piece. The one end of each elastic piece 24 comprises an inverse clamping head. And the another end of each elastic piece 24 comprises a curved buckling portion 26. Each elastic piece 24 is selected from an elastic plastic piece. Each inverse clamping head 25 and each curved buckling portion 26 are integrated together with each elastic piece 24 (e.g., each inverse clamping head 25, each curved buckling portion 26, and each elastic piece 24 are integrally injection molded with silicone rubber material)

An upper edge of one side wall of each pill storage cavity 12 has a recess 13. When assembly, as shown in FIGS. 1,2, and 4, each curved buckling portion 25 passes through each engaging hole 22 and hooks on an edge of each engaging hole 22, and another end of each elastic piece 24 is buckled with the recess 13, that is, the curved buckling portion 26 is buckled with the recess 13. A locking buckle 14 matched with each pill storage cavity 12 is disposed on a front end of the box body 1. A buckle hole 23 is disposed on the front end of each cover 2. Each buckle hole 23 of each cover 2 is buckled with each locking buckle 14 when each cover 2 is in a closed state.

In the present disclosure, when taking out or replenishing the pills, another end of each cover 2 is separated from the box body 1, that is, each locking buckle 14 disposed on the front end of the box body 1 is controlled to separate from each buckle hole 23 disposed on the front end of each cover 2. At the moment of separation, each elastic piece 24 deformed by squeezing is restored, so that each cover 2 is automatically turned up to be fully opened. After taking out or replenishing the pills, each cover 2 is controlled to move downwardly until each cover 2 is buckled with the box body 1 (e. g., each buckle hole 23 at the front of each cover 2 is snapped into each locking buckle 14). At this time, each elastic piece 24 is squeezed by each cover 2 and deformed.

By providing each elastic piece 24 on each cover 2 of the pill organizer, each cover 2 of the pill organizer of the present disclosure is able to be fully opened automatically, which is convenient to take out and replenish pills, and is simple and fast in operation. Moreover, when the cover 2 is in a closed state, the sealing effect of the pill organizer is stable and reliable, and a service life is long. Further, the pill organizer has an ingenious and compact structure, which is quick and convenient to assemble, is easy to produce, and is conducive to mass production and popularization.

Of course, the box body is assembled from more than one pill box bodies. For example, two adjacent pill box bodies 11 are connected by magnetic attraction. In this embodiment, two adjacent pill box bodies 11 are connected together by a magnetic connecting piece provided on one side of pill box bodies. Or, in another embodiment, the two adjacent pill box bodies 11 are assembled together through a clamping hole disposed on one side and a clamping pin disposed on the other side of the pill box bodies 11. However, the present disclosure is not limited thereto.

In one embodiment, each of the pill box bodies 11 comprises the at least one pill storage cavity defining the upper end opening and at least one cover. In this way, the users are able to arbitrarily combine the pill box bodies 11 according to different usage situations, which is more convenient to use and carry. In addition, each elastic piece 24 is also able to be selected from an elastic metal piece, such as a metal dome.

The above are some optional embodiments of the present disclosure. It should be understood that for those ordinary skilled in the art, without departing from the principles of the present disclosure, several improvements and retouches can be made, which is also regarded as within the protection scope of the present disclosure.

What is claimed is:

1. A pill organizer, comprising a box body (1); wherein the box body (10) comprises at least one pill storage cavity (12) and at least one cover (2); the pill storage cavity (12) defining an upper end opening; the cover (2) is matched with the upper end opening and is disposed on the upper end opening of the pill storage cavity (12); one end of the cover (2) is rotatably connected with the box body (1); another end of the cover (2) is detachably buckled with the box body (1); an elastic piece (24) is disposed om an inner surface of the one end of the cover (2) rotatably connected with the box body (1); one end of the elastic piece (24) is fixed on the box body (1); another end of the elastic piece (24) of the cover (2) is buckled with one side of the pill storage cavity (12) of the box body (1).

2. The pill organizer according to claim 1, wherein an upper edge of one side wall of the pill storage cavity(l2) has a recess (13); and another end of the elastic piece (24) of the cover (2) is buckled with the recess (13).

3. The pill organizer according to claim 2, wherein a clamping seat (2l.) is disposed on a rear end of an inner surface of the cover (2); and an engaging hole (22) is disposed on the clamping seat(21); the elastic piece (24) is an S-shaped elastic piece or an L-shaped elastic piece; the one end of the elastic piece (24) comprises an inverse clamping head (25), and the another end of the elastic piece (24) comprises a curved buckling portion (26); when assembly, the curved buckling portion (26) passes through the engaging hole (22) and hooks on an edge of the engaging hole (22), and the curved buckling portion (26) is buckled with the recess (13).

4. The pill organizer according to claim 3, wherein the clamping seat (is integrated together with the cover (2); the inverse clamping head (25)) and the curved buckling portion (26) are integrated together with the elastic piece (24).

5. The pill organizer according to claim 1, wherein the elastic piece (24) is an elastic plastic piece or an elastic metal piece.

6. The pill organizer according to claim 1, wherein an rear end of the cover (2) is rotatably connected with an rear end of the pill storage cavity (12) of the box body (1); a front end of the cover (2) is detachably buckled with a front end of the pill storage cavity (12) of the box body (1); the one end of the elastic piece (24) is fixed on an inner surface of the rear end of the cover (2), and the another end of the elastic piece (24) is buckled with the rear end of the pill storage cavity (12) of he box body (1).

7. The pill organizer according to claim 6, wherein a locking buckle (14) matched with the pill storage cavity (12) is disposed on a front end of the box body (1), and a buckle hole (23) is disposed on the front end of the cover (2); the buckle hole (23) of the cover (2) is buckled with the locking buckle (14) when the cover (2) is closed.

8. The pill organizer according to claim 1, wherein the box body (1) comprises at least one row of pill storage cavities (12) arranged side by side along a longitudinal direction of the box body.

9. The pill organizer according to claim 1, wherein the box body (1) is assembled from more than one pill box bodies (11); two adjacent pill body bodies(11) are connected by magnetic attraction; each of the pill box bodies (11) comprises the at least one pill storage cavity (12) defining the upper end opening and at least one cover (2).
